(19) United States
(12) Patent Application Publication
(10) Pub. No.: US 2025/0160300 A1
(43) Pub. Date: May 22, 2025

(54) A SAFETY APPARATUS FOR ANIMAL HUSBANDRY

(71) Applicant: TUCAN CONSTRUCTION LIMITED, Ardfert, County Kerry (IE)

(72) Inventor: William O'LEARY, Ardfert, County Kerry (IE)

(73) Assignee: TUCAN CONSTRUCTION LIMITED, Ardfert, County Kerry (IE)

(21) Appl. No.: 18/840,330

(22) PCT Filed: Mar. 21, 2023
(86) PCT No.: PCT/EP2023/057177

§ 371 Date: Aug. 21, 2024

(30) Foreign Application Priority Data
Apr. 8, 2022 (EP) 22167442.7

(51) Int. Cl. A01K 15/04; A01K 13/00

(52) U.S. Cl. CPC A01K 15/04; A01K 13/005

(57) ABSTRACT

A safety apparatus for animal husbandry, especially cows while being milked in stalls in a milking parlour. A frame supports a pair of opposed clamps pivotally mounted to the frame to move towards each other to gain purchase on the hips of an animal. Actuators mounted at a rear end of the apparatus for creating (rearwardly and downwards)/releasing (upwardly) and forwardly) tension of the clamps via a cable assembly. There may alternatively be a chain which is directly actuated by a user, and this may engage teeth for setting desired clamping tension. A tail lifting arm pivots from the rear of the apparatus for movement between an upper position holding an animal's tail upwardly, and a released position, the tail holder being engageable with a tool for causing this movement. In the operative position the tail jack is retained by a pawl engaging a rack on the frame, itself attached to the animal by the tensioned clamps.

### INTRODUCTION

The present invention relates to safety for animal husbandry, especially during milking of cows.

It is well known that manual lifting of the tail of all bovine animals greatly restricts the animal's ability to kick. Inhibiting kicking is useful for a range of animal husbandry activities, not least, milking of dairy cows. However, attempts to achieve this effect with an apparatus have not been very successful. U.S. Pat. No. 1,450,774 (Hearing) describes a mechanism with an overhead beam to which a cable is attached. U.S. Pat. No. 1,047,808 (Hinkle) describes a crupper for horses, which is a harness-like arrangement engaging around the horse's body. U.S. Pat. No. 1,047,104 describes a cow holder with pivoting arms linked with a horizontal axis pivot joint above the animal in use. U.S. Pat. No. 1,012,165 (Schimke) describes a scissors-type arrangement for mounting over and around the cow. U.S. Pat. No. 3,736,906 (Peterson) describes an animal tail holder having an apparatus engaging around the hind quarter and linked by a chain to the neck. U.S. Pat. No. 2,762,334 (Allen) describes a restraining device with a rectangular frame over the animal's hind quarter.

U.S. Pat. No. 5,014,648 (Konitzer) describes a cow anti-kick apparatus with a holding means mounted on a clamping means which has a bar with holes for pegs to be placed to set distance of the tail holder.

The present invention is directed towards providing a safety apparatus which is significantly easier to use than those described in the art and is highly effective at inhibiting bovines kicking by raising and holding the tail of the animal securely.

### SUMMARY OF THE INVENTION

We describe a safety apparatus for animal husbandry, the apparatus comprising:
a frame,
a pair of opposed clamps pivotally mounted to the frame to move towards each other to engage the hips of an animal,
a clamp actuator mechanism for causing movement of the clamps together to engage the hips of an animal,
a tail holder for holding an animal's tail upwardly,
a tail holder actuator for movement to cause engagement and disengagement of the holder under user control, and
an elongate tool having a proximal end for gripping by a user and a distal end for engaging the tail holder actuator to cause engagement and disengagement of the tail holder.

In some preferred examples, the tail holder comprises a pawl or engaging a rack. In some preferred examples, the rack is mounted to the frame to extend forwardly, and the pawl is pivotally mounted to a holder actuator arm for engagement with the tool to cause pivotal movement of the arm to assist engagement and disengagement of the pawl and the rack optionally.

In some preferred examples, the apparatus comprises a link extending from an end of the pawl to assist user disengagement of the pawl from the rack.

In some preferred examples, the holder actuator arm supports a tail-engaging bracket, and the arm is configured to remain in an upright position supporting an animal's tail when the pawl engages the rack. In some preferred examples, the bracket is C-shaped. In some preferred examples, the bracket comprises an elongate cradle. In some preferred examples, the cradle has the form of a split tube extending along a direction of the holder actuator arm with a concave side facing distally. In some preferred examples, the cradle is of plastics moulded construction.

In some preferred examples, the holder actuator arm supports an eyelet for engagement with the tool to allow a user standing away from an animal to move the holder actuator arm.

In some preferred examples, the clamp actuator mechanism is adapted to convert rearward movement of an actuator to closing movement of the clamps. In some preferred examples, the clamp actuator comprises at least one arm pivotally mounted on the frame and linked to the clamps. In some preferred examples, the clamp actuator comprises an engagement means for engagement with the tool so that the tool can cause it to pivot to cause clamping of the clamps or release of the clamps. In some preferred examples, each clamp actuator arm is linked to the clamps so that rearward pivoting of said arm causes closing of the clamps.

In some preferred examples, the clamp actuator mechanism comprises a cable assembly linking the actuator arm to the clamps, rearward movement of each clamp actuator arm pulling the clamps together.

In some preferred examples, the cable assembly has at least one longitudinally extending cable linked to a transverse cable, such that rearward movement of the longitudinal cable causes the transverse cable to be pulled into a V shape to cause the clamps to be pulled together.

In some preferred examples, the transverse cable extends through eyelets of the clamps.

In some preferred examples, the clamp actuator comprises a pair of lateral actuators linked by longitudinal cables to the transverse cable and an intermediate actuator linked to an intermediate longitudinal cable.

In some preferred examples, the clamp actuator comprises an actuator which extends substantially rearwardly and is adapted to pull the clamps together if the actuator is pulled rearwardly. In some preferred examples, said actuator comprises a chain. In some preferred examples, the clamp actuator comprises an element for engaging the actuator to retain it at a certain position for desired clamp closing tension. In some preferred examples, the actuator comprises a chain and the element comprises a tooth mounted to the frame.

In some preferred examples, the tool comprises a hook for engaging an animal's tail to assist moving it into engagement with the tail holder.

In some preferred examples, the frame comprises a frame member extending transversely, and the clamps and the clamp actuators are mounted to the frame to move to a folded inoperative position where they are substantially co-planar for compactness.

In some preferred examples, the frame member has a raised central portion corresponding to location of an animal's spine.

We also describe a safety apparatus for animal husbandry, the apparatus comprising:
a frame,
a pair of opposed clamps pivotally mounted to the frame to move towards each other to engage the hips of an animal,
a clamp actuator mechanism for causing movement of the clamps together to engage the hips of an animal,
a tail holder for holding an animal's tail upwardly, and
a tail holder actuator for movement to cause engagement and disengagement of the holder under user control.

The actuators may be operated manually, but it is preferable that the apparatus further comprises an elongate tool having a proximal end for gripping by a user and a distal end for engaging the tail holder actuator to cause engagement and disengagement of the tail holder. Preferably, the tail holder comprises a pawl for engaging a rack.

Preferably, rack is mounted to the frame to extend forwardly, and the pawl is pivotally mounted to an actuator arm for engagement with the tool to cause pivotal movement of the arm to assist engagement and disengagement of the pawl and the rack, and there is preferably a link such as a cable extending from an end of the pawl to assist user disengagement of the pawl from the rack against spring pressure. Preferably, the holder actuator arm supports a tail-engaging bracket, and the arm is configured to remain in an upright position supporting an animal's tail when the pawl engages the rack. Preferably, the bracket is C-shaped.

Preferably, the holder actuator arm supports an eyelet for engagement with the tool to allow a user standing away from an animal to move the holder actuator. Preferably, the clamp actuator mechanism is adapted to convert rearward movement of an actuator to closing movement of the clamps. Preferably, the clamp actuator comprises at least one arm pivotally mounted on the frame and linked to the clamps.

Preferably, the clamp actuator comprises an engagement means for engagement with the tool so that the tool can cause it to pivot to cause clamping of the clamps or release of the clamps. Preferably, each clamp actuator arm is linked to the clamps so that rearward pivoting of said arm causes closing of the clamps.

Preferably, the clamp actuator mechanism comprises a cable assembly linking the actuator arm to the clamps, rearward movement of each clamp actuator arm pulling the clamps together. In one example, the cable assembly has at least one longitudinally extending cable linked to a transverse cable, such that rearward movement of the longitudinal cable causes the transverse cable to be pulled into a V shape to cause the clamps to be pulled together. Preferably, the transverse cable extends through eyelets of the clamps.

Preferably, the clamp actuator comprises a pair of lateral actuators linked by longitudinal cables to the transverse cable and an intermediate actuator linked to an intermediate longitudinal cable.

In one example, the clamp actuator comprises an actuator such as a rope which extends substantially rearwardly and is adapted to pull the clamps together if the actuator is pulled rearwardly.

Preferably, the tool comprises a hook for engaging an animal's tail to assist moving it into engagement with the tail holder. Preferably, the frame comprises a frame member extending transversely and the clamps and the clamp actuators are mounted to the frame to move to a folded inoperative position where they are substantially co-planar for compactness. Preferably, the frame member has a raised central portion corresponding to location of an animal's spine.

### DETAILED DESCRIPTION OF THE INVENTION

The invention will be more clearly understood from the following description of some embodiments thereof, given by way of example only with reference to the accompanying drawings in which:

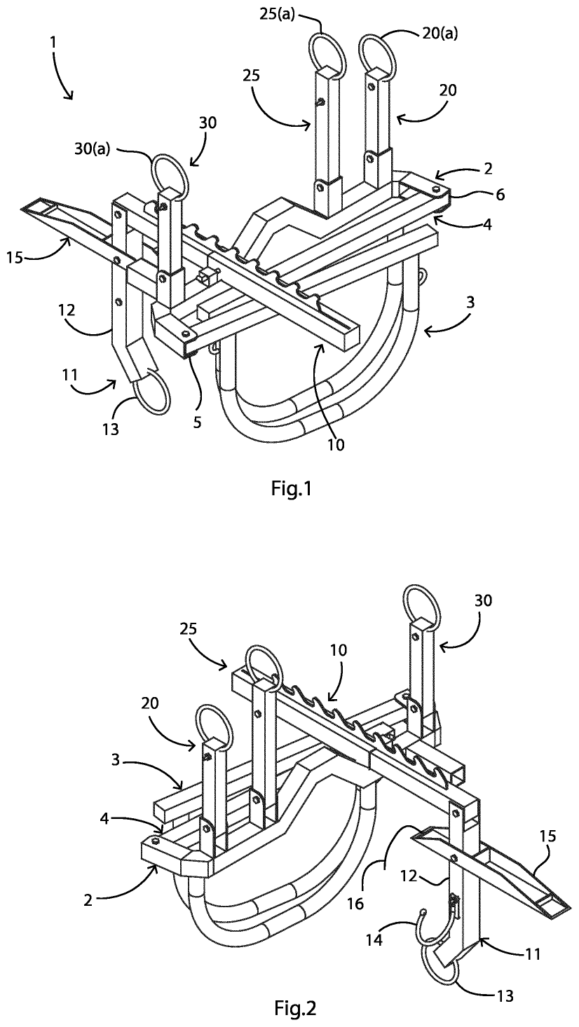

FIGS. 1 and 2 are front and rear perspective views of a safety apparatus of the invention when in a folded, collapsed position,

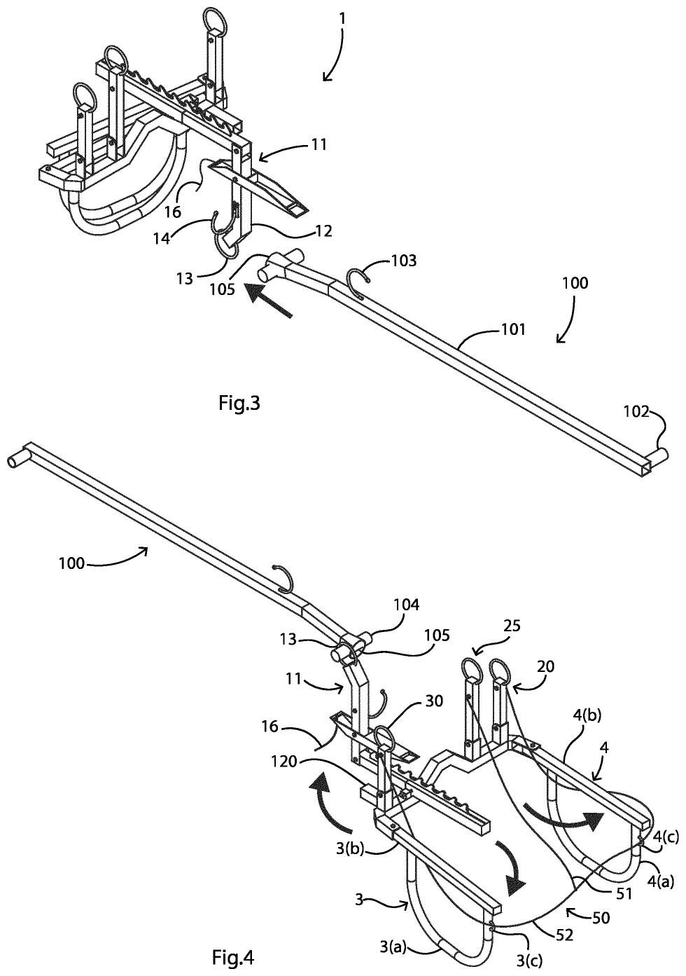

FIG. 3 is a perspective view from the rear showing a hand tool being introduced to the apparatus, and FIG. 4 is a perspective view from the front showing the tool after being engaged with a tail holding actuator,

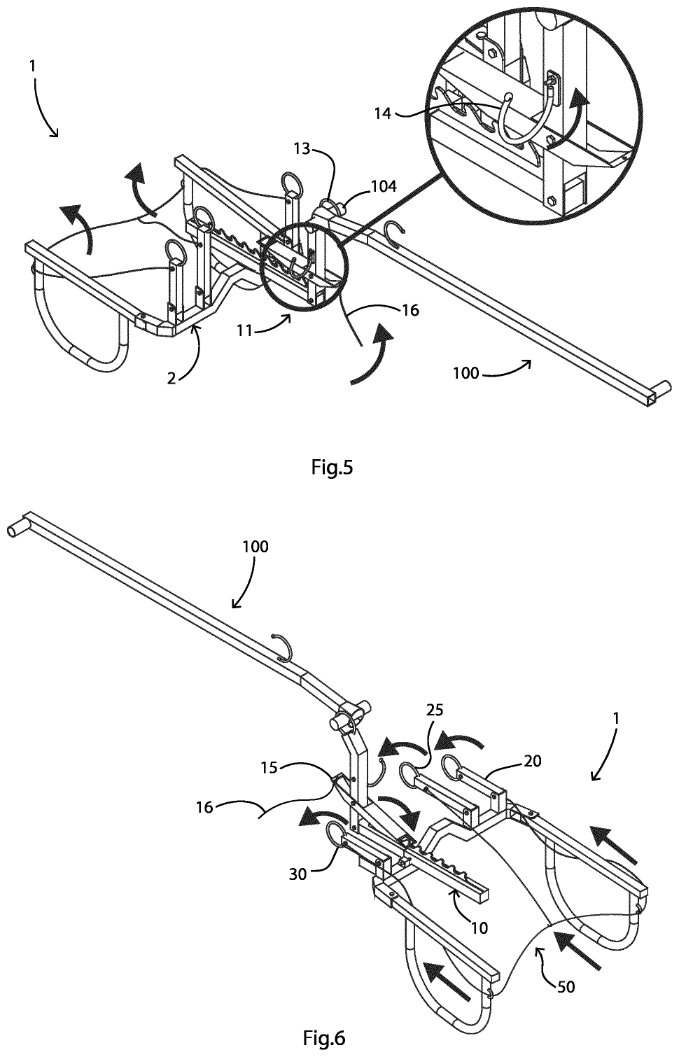

FIG. 5 is a perspective view showing movement of a tail holder C-shaped bracket to an operative position,

FIG. 6 is a perspective view showing rearward movement of the clamping actuators to bring the clamp into an operative position,

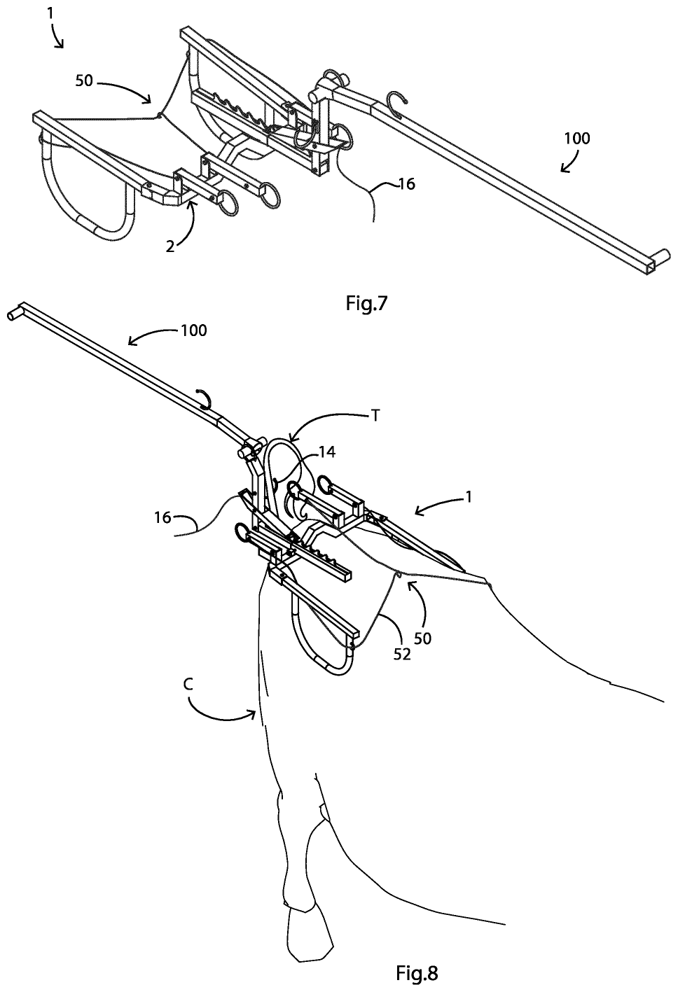

FIGS. 7 and 8 are perspective views showing the apparatus in the operative position in use,

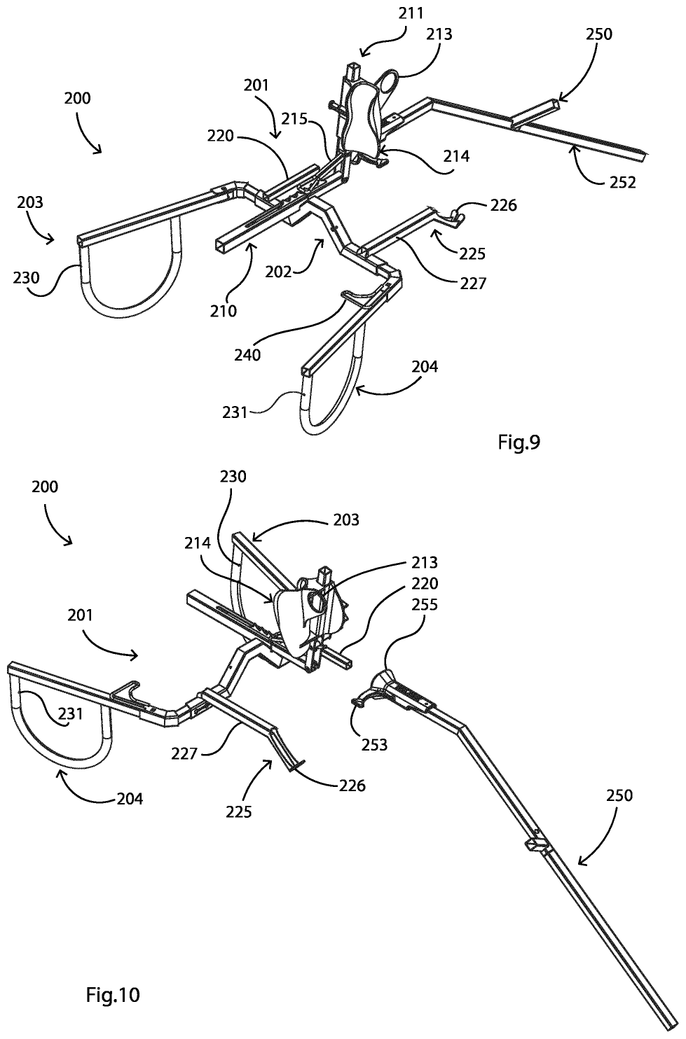

FIGS. 9 and 10 are top perspective views from opposite sides of an alternative safety apparatus of the invention, and

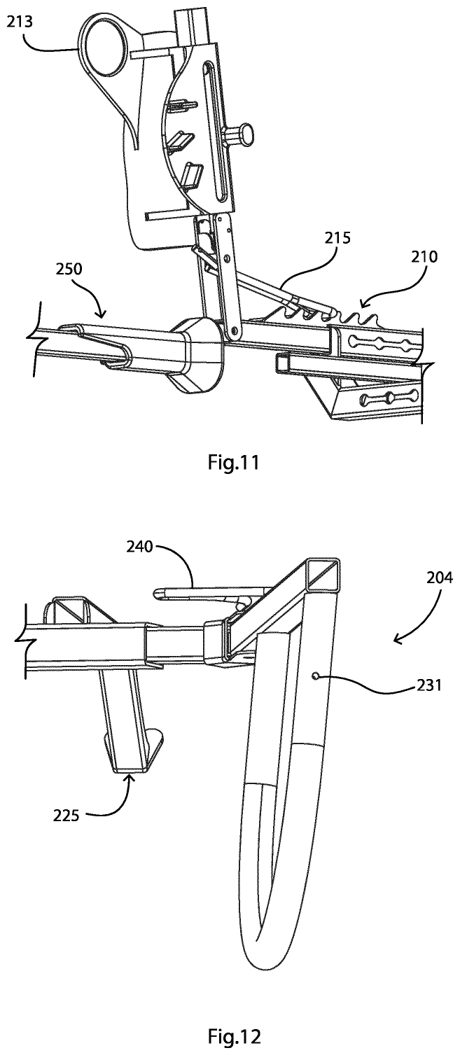

FIGS. 11 and 12 are close-up perspective views of parts of the apparatus of FIGS. 9 and 10.

Referring to the drawings, a safety apparatus 1 can have a collapsed position as shown in FIGS. 1 to 3, and the remaining drawings show the apparatus in various stages of being opened out in use. The apparatus 1 comprises a frame 2 to which are hinged a pair of clamps 3 and 4 which pivot about joints 5 and 6 respectively about vertical axes.

These vertical axes are in use on either side of the back of a cow. The clamps 3 and 4 have downwardly depending curved bars 3(a) and 4(a) respectively, and these are fixed to longitudinal straight bars 3(b) and 4(b) respectively. It is the straight bars 3(b) and 4(b) which pivot about the joints 5 and 6 respectively.

The frame 2 also supports a central and longitudinal rack 10 with forwardly directed teeth 10(a). At the rear end of the rack 10 there is a tail holder 11 which pivots about a horizontal axis. It comprises an arm 12 at the end of which there is a ring 13 for engaging a tool, as described in more detail below. The arm 12 also has a tail-engaging C-shaped bracket 14 near the end of the arm 12. Also, a pawl 15 is pivotally engaged with the arm 12, to pivot about an axis transversely through the arm 12, for engagement with the pawl teeth 10(a) when the holder 11 is in an upper, operative, position.

There are three clamp actuators 20, 25, and 30 comprising arms pivotally connected to the frame 2 for rotation about a horizontal axis in use between an upper collapsed position and a rearwardly facing operative position. The actuators 20, 25, and 30 comprise rings 20(a), 25(a), and 30(a) respectively, for engagement with a tool for user movement of them between the folded and operative positions.

A cable assembly 50 has three longitudinal cables 51, one connected to each of the clamp actuators 20, 25, and 30. The cable assembly 50 also has a transverse cable 52 extending through eyelets 3(c) and 4(c) of the clamps 3 and 4. A central longitudinal strand 51 engages the actuator 25 and the transverse cable 5 engages the opposed clamps 3 and 4. Rearward pivotal movement of the clamp actuators 20, 25, and 30 causes the clamps 3 and 4 to be pulled together, the cable assembly 50 forming a Y-shape as illustrated. It is advantageous that a tool can be used from behind and below the cow (as in a milking parlour) to engage the rings 20(a), 25(a) and 30(a) to pull them back.

This is one example of a mechanism for actuating the clamp, and it is advantageous because of its reliability and simplicity. An important advantage of the invention is that an action of pulling back an actuator has the effect of, via the actuator mechanism, drawing the clamps together. Others are possible as will be appreciated by those skilled in the art.

For example, alternative actuator mechanisms may include a rope, a pulley, and a rope lock device. Alternatively, adjustment could be made using an eye and eyelet mechanism and an anchor bolt and tension adjustment bar with several oblong holes. Alternatively, there may be a chain whereby choosing a link to engage/hook would adjust the tension. An example of the latter is described below with reference to FIGS. 9 to 12. Alternatively, there may be two hinged bars creating a V shape. This might have one actuator but would require an adjuster to perform the action of the actuators 20 and 30. The important aspect is that a user can use a tool to pull an actuator rearwardly and this movement is converted to inward transverse movement of the clamps towards each other.

Actuation of the tail holder is done with the assistance of a tool 100 having an arm 101 of about 1 m length, a handle 102 at the proximal end, a transverse bar 104 at the distal end, and a hook 103 near the distal end. Also, the end of the tool 100 has an open end 105 forming a socket to assist with holding the apparatus 1 by way of the engagement with a male spigot 120 on the frame 2.

In use, the apparatus 1 a user does the following.
Opens out the apparatus from the folded position of FIGS. 1 to 3 to the position shown in FIGS. 4 and 5.
Places the apparatus over the rear end of the back of the cow C (FIG. 8), typically when the cow is in an elevated position in a milking parlour and the user is in a passage behind the stall-standing on a level lower than the cow. This placement is done with the tool distal socket 105 engaging the spigot 120, allowing the user to use the tool 100 to lift and place the apparatus 1. When in place, the user simply retracts the tool 100 to disengage it from the spigot 120.
The tool 100 can be used to engage the rings or eyelets 20(a), 25(a), and 30(a) to pull the actuators 20, 25, and 30 rearwardly as shown in FIGS. 6 to 8 so that the cable assembly 50 pulls the clamps 3 and 4 towards each other to engage tightly the hips of the animal. This is a simple action, especially due to the fact that the central longitudinal cable 51 pulls the transverse cable 52 into a V-shape with the apex facing rearwardly.
The user then, using the hook 103 of the tool 100, manually places the tail in the C-Shaped tail holder bracket 14.
The user engages the tool 100 with the ring 13 and rotates the holder 11 upwardly and forwardly sufficiently to cause the pawl 15 to fall forwardly and engage the teeth 10(a) so that the tail—is jacked to the desired extent.
The apparatus maintains tail elevation without human assistance with the clamps 3 and 4 holding it in position and the tail holder 11 being stable due to engagement of the pawl 15 with the rack 10.

To remove the apparatus 1, it is simply a matter of a user doing the following.
Engaging the tool bar 104 with the ring 13 and pushing the tail holder 11 forwardly to allow tension on the pawl 15 to be relieved.
With the pawl 15 tension relieved, pulling a string 16 on the pawl 15 thereby pivoting the pawl 15 about the holder arm 12, causing the pawl to lift from the teeth 10(a) of the rack 10. This is followed by release of forward pressure on the ring 13 to allow the holder 11 to fall back, lowering the tail T in the attached C-shaped tail holder bracket 14.
The tail is manually, with use of the tool hook 103, removed from the C-shaped holder bracket 14.
Pushing the actuators 20, 25, and 30 upwardly and forwardly, thereby allowing the clamps 3 and 4 to separate, reducing grip on the hips.
The tool female socket 105 can then engage the male spigot 120 which is attached to the frame 2 between lever 30 and the pawl 10, facilitating removal of the apparatus 1 from behind and below the animal.

Referring to FIGS. 9 to 12, an alternative safety apparatus 200 is shown. This operates on the same principles as the apparatus 1/100. The apparatus 200 has a main part 201 and an actuator 250. The main part 201 has a frame 202 to which are pivotally mounted clamps 203 and 204, for pivoting about vertical axes in a manner similar to the clamps 3 and 4. A holder 211 pivots in a manner similar to the holder 11 and has a pivotally mounted pawl 215 for operation in a manner similar to the holder 11 and pawl 15, with engagement with a rack 210 having forwardly directed teeth. As for the apparatus 1 cable 16 there is a cable or chain (not shown) attached to the pawl 215. to release it. The frame 202 has a rearwardly-extending spigot 220 to allow the apparatus to be lifted by the tool 250, in a manner akin to use of the spigot 120. The tool 250 has a proximal handle end 252, a distal socket 255 for engaging the spigot 220, and a lateral hook 253. The tool 250 can be used in a manner similar to the tool 100, the socket 255 engaging the spigot 220 to lift the apparatus and place it on the cow and subsequently to remove it. The hook 253 engages an eyelet 213 on the holder 211 to rotate the holder 211 to its upward position for engagement of the pawl 215 with the rack 210. In this case the holder 211 has a plastics cradle 214 which tends to engage the tail and lift it upwardly without need for the user to manipulate the tail. However, if this is needed the hook 253 can be used for this purpose. It is advantageous that the cradle 214 is curved in a generally split tubular form being concave towards the distal direction. The rear of the cradle has formations which may be engaged by the tool 250 to push the actuator 211 up, as shown most clearly in FIG. 11.

The apparatus 200 also has a lifting handle 240 on the clamp 204, for carrying when not in use.

In this case the clamping is caused by the user pulling on a chain which is linked with the clamps 203 and 204 at holes 230 and 231, and the chain is trained along a guide 227 of an arm 225 and a link of the chain is engaged with a pair of teeth 226 on the proximal end of the arm 225. The actuation of clamping around the hips of the cow are as described for the apparatus 1, 2 D shackles being placed in the holes 230 and 231 and these are connected to a chain which runs through the guide 227 which can be locked by engaging the teeth 226. A pulley may be provided between the clamps 203 and 204 to convert forward/backwards tension to lateral tensioning of the clamps 203 and 204 around the animal's hips.

The user pulls the chain until it is taut and engages a relevant link with the teeth 226 to leave it at the desired tension.

The benefits and features of the safety apparatus are that bovine can be more effectively prevented from kicking, reducing risk of injury, and saving labour required for alternative methods.

It will be appreciated that the apparatus is significantly more effective in inhibiting kicking in comparison to those known in the art. The apparatus 1 can be applied and manipulated from the milking parlor floor from a safer distance using the tool 100 by a lone individual. Prior methods require getting close to the animal and risking injury.

During milking and other animal husbandry practices or veterinary procedures, the user can reliably inhibit kicking with the apparatus. Also, the assistance of a second person would typically have been sought to manually lift and hold the tail, and this is avoided by the invention. Manually holding the tail often requires climbing on the milking parlor structure which entails health and safety risks including falling.

The invention avoids the problem of prior art devices by avoiding an individual taking many minutes to improvise a form of restraint (for example, using ropes) and reducing physical risk of the person being kicked, disruption and delay. In the case of a lone milker this has been particularly problematic. In addition to milking, the apparatus may be employed by both farmers and veterinary practitioners during treatments of animals, such as treatment of udder infections and injuries. The apparatus dispenses with need for a second person when performing such treatments.

In comparison to those described in the art, the present invention is simple and easy to use. Furthermore, it is highly effective at inhibiting kicking by raising and holding the tail of the animal securely and thus is a desirable safety apparatus.

Components of embodiments can be employed in other embodiments in a manner as would be understood by a person of ordinary skill in the art. The invention is not limited to the embodiments described but may be varied in construction and detail.

1. A safety apparatus for animal husbandry, the apparatus comprising:
a frame,
a pair of opposed clamps pivotally mounted to the frame to move towards each other to engage the hips of an animal,
a clamp actuator mechanism for causing movement of the clamps together to engage the hips of an animal,
a tail holder for holding an animal's tail upwardly,
a tail holder actuator for movement to cause engagement and disengagement of the holder under user control, and
an elongate tool having a proximal end for gripping by a user and a distal end for engaging the tail holder actuator to cause engagement and disengagement of the tail holder.

2. The safety apparatus as claimed in claim 1, wherein the tail holder comprises a pawl for engaging a rack.

3. The safety apparatus as claimed in claim 1, wherein the tail holder comprises a pawl for engaging a rack; and wherein the rack is mounted to the frame to extend forwardly, and the pawl is pivotally mounted to a holder actuator arm for engagement with the tool to cause pivotal movement of the arm to assist engagement and disengagement of the pawl and the rack optionally.

4. The safety apparatus as claimed in claim 1, wherein the tail holder comprises a pawl for engaging a rack; and wherein the rack is mounted to the frame to extend forwardly, and the pawl is pivotally mounted to a holder actuator arm for engagement with the tool; and wherein the apparatus comprises a link extending from an end of the pawl to assist user disengagement of the pawl from the rack.

5. The safety apparatus as claimed in claim 1, wherein the tail holder comprises a pawl for engaging a rack; and wherein the rack is mounted to the frame to extend forwardly, and the pawl is pivotally mounted to a holder actuator arm for engagement with the tool; and wherein the holder actuator arm supports a tail-engaging bracket, and the arm is configured to remain in an upright position supporting an animal's tail when the pawl engages the rack.

6. The safety apparatus as claimed in claim 1, wherein the tail holder comprises a pawl for engaging a rack; and wherein the rack is mounted to the frame to extend forwardly, and the pawl is pivotally mounted to a holder actuator arm for engagement with the tool; and wherein the holder actuator arm supports a tail-engaging bracket, and the arm is configured to remain in an upright position supporting an animal's tail when the pawl engages the rack; and wherein the bracket is C-shaped.

7. The safety apparatus as claimed in claim 1, wherein the tail holder comprises a pawl for engaging a rack; and wherein the rack is mounted to the frame to extend forwardly, and the pawl is pivotally mounted to a holder actuator arm for engagement with the tool; and wherein the holder actuator arm supports a tail-engaging bracket, and the arm is configured to remain in an upright position supporting an animal's tail when the pawl engages the rack; and wherein the bracket is C-shaped; and wherein the bracket comprises an elongate cradle.

8. The safety apparatus as claimed in claim 1, wherein the tail holder comprises a pawl for engaging a rack; and wherein the rack is mounted to the frame to extend forwardly, and the pawl is pivotally mounted to a holder actuator arm for engagement with the tool; and wherein the holder actuator arm supports a tail-engaging bracket, and the arm is configured to remain in an upright position supporting an animal's tail when the pawl engages the rack; and wherein the bracket is C-shaped; and wherein the bracket comprises an elongate cradle; and wherein the cradle has the form of a split tube extending along a direction of the holder actuator arm with a concave side facing distally; and wherein the holder actuator arm supports an eyelet for engagement with the tool to allow a user standing away from an animal to move the holder actuator arm.

9. (canceled)

10. (canceled)

11. The safety apparatus as claimed in claim 1, wherein the clamp actuator mechanism is adapted to convert rearward movement of an actuator to closing movement of the clamps.

12. The safety apparatus as claimed in claim 1, wherein the clamp actuator comprises at least one arm pivotally mounted on the frame and linked to the clamps; wherein the clamp actuator mechanism is adapted to convert rearward movement of an actuator to closing movement of the clamps; and wherein the clamp actuator comprises an engagement means for engagement with the tool so that the tool can cause it to pivot to cause clamping of the clamps or release of the clamps.

13. (canceled)

14. The safety apparatus as claimed in claim 1, wherein the clamp actuator comprises at least one arm (20, 25, 30) pivotally mounted on the frame and linked to the clamps; wherein the clamp actuator mechanism is adapted to convert rearward movement of an actuator to closing movement of the clamps; and wherein the clamp actuator comprises an engagement means for engagement with the tool so that the tool can cause it to pivot to cause clamping of the clamps or release of the clamps; and wherein each clamp actuator arm is linked to the clamps so that rearward pivoting of said arm causes closing of the clamps.

15. The safety apparatus as claimed in claim 1, wherein the clamp actuator comprises at least one arm (20, 25, 30) pivotally mounted on the frame and linked to the clamps; wherein the clamp actuator mechanism is adapted to convert rearward movement of an actuator to closing movement of the clamps; and wherein the clamp actuator comprises an engagement means for engagement with the tool so that the tool can cause it to pivot to cause clamping of the clamps or release of the clamps; and wherein each clamp actuator arm is linked to the clamps so that rearward pivoting of said arm causes closing of the clamps; and wherein the clamp actuator mechanism comprises a cable assembly linking the actuator arm to the clamps, rearward movement of each clamp actuator arm pulling the clamps together.

16. The safety apparatus as claimed in claim 1, wherein the clamp actuator comprises at least one arm (20, 25, 30) pivotally mounted on the frame and linked to the clamps; wherein the clamp actuator mechanism is adapted to convert rearward movement of an actuator to closing movement of the clamps; and wherein the clamp actuator comprises an engagement means for engagement with the tool so that the tool can cause it to pivot to cause clamping of the clamps or release of the clamps; and wherein each clamp actuator arm is linked to the clamps so that rearward pivoting of said arm causes closing of the clamps; and wherein the clamp actuator mechanism comprises a cable assembly linking the actuator arm to the clamps, rearward movement of each clamp actuator arm pulling the clamps together; and wherein the cable assembly has at least one longitudinally extending cable linked to a transverse cable, such that rearward movement of the longitudinal cable causes the transverse cable to be pulled into a V shape to cause the clamps to be pulled together.

17. (canceled)

18. The safety apparatus as claimed in claim 1, wherein the clamp actuator comprises at least one arm pivotally mounted on the frame and linked to the clamps; wherein the clamp actuator mechanism is adapted to convert rearward movement of an actuator to closing movement of the clamps; and wherein the clamp actuator comprises an engagement means for engagement with the tool so that the tool can cause it to pivot to cause clamping of the clamps or release of the clamps; and wherein each clamp actuator arm is linked to the clamps so that rearward pivoting of said arm causes closing of the clamps; and wherein the clamp actuator mechanism comprises a cable assembly linking the actuator arm to the clamps, rearward movement of each clamp actuator arm pulling the clamps together; and wherein the cable assembly has at least one longitudinally extending cable linked to a transverse cable, such that rearward movement of the longitudinal cable causes the transverse cable to be pulled into a V shape to cause the clamps to be pulled together; and wherein the clamp actuator comprises a pair of lateral actuators linked by longitudinal cables to the transverse cable and an intermediate actuator linked to an intermediate longitudinal cable.

19. The safety apparatus as claimed in claim 1, wherein the clamp actuator mechanism is adapted to convert rearward movement of an actuator to closing movement of the clamps; and wherein the clamp actuator comprises an actuator which extends substantially rearwardly and is adapted to pull the clamps together if the actuator is pulled rearwardly.

20. (canceled)

21. The safety apparatus as claimed in claim 1, wherein the clamp actuator mechanism is adapted to convert rearward movement of an actuator to closing movement of the clamps; and wherein the clamp actuator comprises an actuator which extends substantially rearwardly and is adapted to pull the clamps together if the actuator is pulled rearwardly; and wherein the clamp actuator comprises an element for engaging the actuator to retain it at a certain position for desired clamp closing tension.

22. The safety apparatus as claimed in claim 1, wherein the actuator comprises a chain and the element comprises a tooth mounted to the frame; wherein the clamp actuator mechanism is adapted to convert rearward movement of an actuator to closing movement of the clamps; and wherein the clamp actuator comprises an actuator which extends substantially rearwardly and is adapted to pull the clamps together if the actuator is pulled rearwardly; and wherein the clamp actuator comprises an element for engaging the actuator to retain it at a certain position for desired clamp closing tension.

23. The safety apparatus as claimed in claim 1, wherein the tool comprises a hook for engaging an animal's tail to assist moving it into engagement with the tail holder.

24. The safety apparatus as claimed in claim 1, wherein the frame comprises a frame member extending transversely and the clamps and the clamp actuators are mounted to the frame to move to a folded inoperative position where they are substantially co-planar for compactness.

25. The safety apparatus as claimed in claim 1, wherein the frame comprises a frame member extending transversely, and the clamps and the clamp actuators are mounted to the frame to move to a folded inoperative position where they are substantially co-planar for compactness; and wherein the frame member has a raised central portion corresponding to location of an animal's spine.
